(19) United States
(12) Patent Application Publication
(10) Pub. No.: US 2012/0254809 A1
(43) Pub. Date: Oct. 4, 2012

(54) METHOD AND APPARATUS FOR MOTION GESTURE RECOGNITION

(75) Inventors: Jun Yang, Milpitas, CA (US); Hawk-Yin Pang, San Jose, CA (US); Wenbo Zhao, San Diego, CA (US); Zhigang Liu, Sunnyvale, CA (US)

(73) Assignee: Nokia Corporation

(21) Appl. No.: 13/077,008

(22) Filed: Mar. 31, 2011

(51) Int. Cl. G06F 3/033

(52) U.S. Cl. 715/863

(57) ABSTRACT

Various methods for motion gesture recognition are provided. One example method may include receiving motion gesture test data that was captured in response to a user's performance of a motion gesture. The motion gesture test data may include acceleration values in each of three dimensions of space that have directional components that are defined relative to an orientation of a device. The example method may further include transforming the acceleration values to derive transformed values that are independent of the orientation of the device, and performing a comparison between the transformed values and a gesture template to recognize the motion gesture performed by the user. Similar and related example methods, example apparatuses, and example computer program products are also provided.

### TECHNICAL FIELD

Various embodiments relate generally to user interface functionality, and, more particularly, relate to a method and apparatus for motion gesture recognition.

### BACKGROUND

As computing and communications devices become increasingly more dynamic and convenient, users of the devices have become increasingly reliant on the functionality offered by the devices in a variety of settings. Due to advances made in screen technologies, accelerometers and other user interface input devices and hardware, users continue to demand more convenient and intuitive user interfaces. To meet the demands of users or encourage utilization of new functionality, innovation in the design and operation of user interfaces must keep pace.

### SUMMARY

Example methods, example apparatuses, and example computer program products are described herein that provide motion gesture recognition. One example method may include receiving motion gesture test data that was captured in response to a user's performance of a motion gesture. The motion gesture test data may include acceleration values in each of three dimensions of space that have directional components that are defined relative to an orientation of a device. The example method may further include transforming the acceleration values to derive transformed values that are independent of the orientation of the device, and performing a comparison between the transformed values and a gesture template to recognize the motion gesture performed by the user.

An additional example embodiment is an apparatus configured to support motion gesture recognition. The example apparatus may comprise at least one processor and at least one memory including computer program code, where the at least one memory and the computer program code are configured to, with the at least one processor, cause the apparatus to perform various functionalities. In this regard, the example apparatus may be caused to receive motion gesture test data that was captured in response to a user's performance of a motion gesture. The motion gesture test data may include acceleration values in each of three dimensions of space that have directional components that are defined relative to an orientation of a device. The example apparatus may be further caused to transform the acceleration values to derive transformed values that are independent of the orientation of the device, and perform a comparison between the transformed values and a gesture template to recognize the motion gesture performed by the user.

Another example embodiment is a computer program product comprising at least one non-transitory computer readable medium having computer program code stored thereon, wherein the computer program code, when executed by an apparatus (e.g., one or more processors), causes an apparatus to perform various functionalities. In this regard, the program code may cause the apparatus to receive motion gesture test data that was captured in response to a user's performance of a motion gesture. The motion gesture test data may include acceleration values in each of three dimensions of space that have directional components that are defined relative to an orientation of a device. The program code may also cause the apparatus to transform the acceleration values to derive transformed values that are independent of the orientation of the device, and perform a comparison between the transformed values and a gesture template to recognize the motion gesture performed by the user.

Another example apparatus comprises means for receiving motion gesture test data that was captured in response to a user's performance of a motion gesture. The motion gesture test data may include acceleration values in each of three dimensions of space that have directional components that are defined relative to an orientation of a device. The example apparatus may further include means for transforming the acceleration values to derive transformed values that are independent of the orientation of the device, and means for performing a comparison between the transformed values and a gesture template to recognize the motion gesture performed by the user.

### BRIEF DESCRIPTION OF THE DRAWINGS

Having thus described some example embodiments in general terms, reference will now be made to the accompanying drawings, which are not necessarily drawn to scale, and wherein:

FIG. 1 illustrates an example coordinate system according to some example embodiments;

FIG. 2 illustrates an example flowchart for an example operation flow for generating orientation independent values using Principal Component Analysis (PCA) according to an example embodiment;

FIG. 3 illustrates an example flowchart for an example operation flow for generating orientation independent values using a predefined coordinate system according to an example embodiment;

FIGS. 4a-4d illustrate motion direction and orientation relationships that may be used to determine a third rotation angle according to various example embodiments;

FIG. 5 illustrates a block diagram of an apparatus and associated system that is configured to perform motion gesture recognition according to an example embodiment;

FIG. 6 illustrates a block diagram of a mobile device configured to implement perform motion gesture recognition according to an example embodiment; and

FIG. 7 illustrates a flow chart of an example method for performing motion gesture recognition according to some example embodiments.

### DETAILED DESCRIPTION

Example embodiments will now be described more fully hereinafter with reference to the accompanying drawings, in which some, but not all embodiments are shown. Indeed, the embodiments may take many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments, to refer to data capable of being transmitted, received, operated on, and/or stored.

As used herein, the term ‘circuitry’ refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

According to various example embodiments, motion gesture recognition may be utilized to trigger various applications and functionalities that may be implemented by a computing device. Within the context of this application, motion gestures can be specific motions, or series of specific motions, that are performed by a user in a three-dimensional space. In this regard, an individual waving good-bye or drawing a circle with their hand are examples of a motion gestures. A user of a computing device may hold the device, or at least the motion gesture detection hardware, in their hand while the motion gesture is performed in order to permit the motion gesture to be detected and recognized. In some instances, the motion gesture detection hardware may not necessarily be held, but may rather be affixed to, for example, the individual's wrist via a strap.

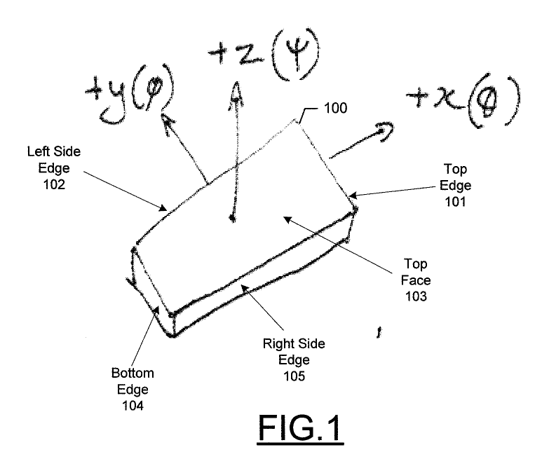

One example of hardware that may be configured to facilitate the detection of motion gestures is an accelerometer sensor. An accelerometer sensor may be used in devices (e.g., mobile devices) to permit the tracking of a user's physical movements by detection of movement accelerating in particular direction. Many accelerometer sensors, possibly with the assistance of supporting hardware and software, generate acceleration values of vectors in each of three dimensions to describe the acceleration of the sensor. FIG. 1 illustrates the coordinate axes that an accelerometer sensor of a device 100 may use to provide relative acceleration values. In this regard, the component of acceleration moving the direction of the top edge 101 (as opposed to the bottom edge 104) may be referred to as acceleration in the positive x direction. The component of acceleration moving the direction of the left side edge 102 (as opposed to the right side edge 105) may be referred to as acceleration in the positive y direction, and the component of acceleration moving the direction of the top face 103 may be referred to as acceleration in the positive z direction. The coordinate axes may also define angles about each of the axes. In this regard, the rotation angle about the x axis may be the angle θ. The rotation angle about they axis may be the angle φ, and the rotation angle about the z axis may be the angle ψ.

Through the accelerometer's ability to track a user's movement within a coordinate axis that is dependent upon the orientation of a device, such as the one depicted in FIG. 1, motion gestures can become an additional user interface option to input a request or data. For example, in response to detection of a particular gesture, a computing device may launch an application or authenticate a user.

When accelerometer sensors that are built into devices, such as mobile phones, the three-dimensional acceleration values that are output from an accelerometer sensors can be dependent on the device's current orientation. The signal or data from accelerometer may be represented as a vector of a three-tuple (x, y, z) that includes the acceleration information in the x, y, and z directions based on the device's current orientation. For personalized motion gesture recognition, a user may therefore be required to train a device (or create a motion gesture template) in consideration of the orientation dependency of the gesture recognition process. For example, if a user creates a motion gesture template using a gesture when the device is held in an upright orientation (e.g., the top edge of a mobile phone screen being closest to the ceiling and bottom edge of the phone screen being closest to the floor), the user may need to ensure that all future gestures are performed with this same orientation for a gesture match to be found.

Many motion gesture recognition techniques use Dynamic Time Warping (DTW) and Hidden Markov Models (HMM) to identify motion gestures. However, if the three-dimensional orientation of the device is not the same during the motion gesture, the DTW or HMM classifier may not be able to recognize the gesture because the three-dimensional acceleration values used to create the motion gesture template are different from the three-dimensional motion gesture test data (the data derived from a motion gesture match attempt or test performed by the user). As such, the usability of such a solution can be insufficient for widespread adoption.

It has been determined that human gestures are often performed in a two-dimensional plane, since two-dimensional motion gestures are easier for a user to remember. However, even given this two-dimensional nature of motion gestures, users often do not necessarily orient the motion gesture in the same relative plane when they perform the gesture, thereby introducing the need to consider aspects of a third dimension when performing motion gesture recognition. Various example embodiments therefore perform motion gesture recognition in consideration of the third dimensional values and permit motion gesture recognition when a device is used in any orientation and the motion gestures are performed in any arbitrary plane.

The usability of three-dimensional motion gestures can be increased if, in accordance with various example embodiments, the data derived from a test motion gesture is rotated such that the rotated test data shares a common plane with the motion gesture template. Motion gesture recognition and value comparisons can then be performed, for example, using DTW or HMM, with respect to the values that contribute to the shared two-dimensional planar space, even though acceleration in three-dimensions was originally being considered to perform the rotation. In this regard, according to some example embodiments, a determination of the rotation angle about each of the three dimensional axes can be determined in order to facilitate motion gesture recognition regardless of the orientation of the device by facilitating the ability to define a common two-dimensional plane. According to some example embodiments, the device orientation variation problem described above can also be resolved through the use of an accelerometer or equivalent hardware, without the need for additional gyros or magnetometers, thereby providing a low cost solution.

According to a first example embodiment, a complete orientation-independent solution for accelerometer-based, or accelerometer only-based, gesture recognition is provided. The example method and associated apparatus embodiments can determine the two-dimensional plane that the motion gesture test data is to be rotated onto by using Principal Component Analysis (PCA). According to various example embodiments, PCA is an orthogonal transformation technique that converts a set of correlated variable values into a set of values of uncorrelated variables called principal components. Since the number of principal components can be less than or equal to the number of original variables, three dimensional acceleration values can be converted or transformed into two dimensional acceleration values. The PCA transformation may be defined such that a first principal component has a maximum variance and accounts for as much of the variability in the data as possible, and each subsequent component has a highest variance possible under the condition that the component is orthogonal to the preceding components.

As such, using PCA, the three-dimensional orientation-dependent motion gestures can be transformed into two-dimensional orientation-independent gestures. DTW or HMM classifiers can then be applied to the resultant two-dimensional acceleration values to perform motion gesture recognition. Additionally, according to some example embodiments, if the gesture is a one dimensional or a three dimensional gesture, the same or a similar technique can be applied to determine a corresponding one-dimension or three-dimension coordinate system of the gesture resulting in orientation independency.

In some instances, an intended motion gesture may vary in time duration and speed. As such, according to various example embodiments, the acceleration values, either before or after transformation using PCA, may be resampled to a fixed length and scaled to a common range.

Additionally, a preprocessing operation may be performed. In this regard, suppose the motion gesture template data set is {Tᵢ(xₙ,yₙ,zₙ)ₙ₌₁^{N}^{ᵢ}, i=1, 2, . . . , I} for a total of I gestures, where there is one single template for each gesture. Given this data set, the following example Create-Template procedure may be used to create new motion gesture template data set which is orientation independent.

Create-Template( )

For each Tᵢ in the template set{Tᵢ(xₙ,yₙ,zₙ)ₙ₌₁^{N}^{ᵢ},i = 1,2,...,I},

Resample Tᵢ to the same length of N;
Remove the gravity vector from Tᵢ;
Scale Tᵢ to the same level of magnitude;

Perform a PCA transformation on Tᵢ;
Use the first and second strongest components of Tᵢ;
Rescale these two components to the same level of
magnitude;

The new 2-D template set is {Tᵢ (xₙ,yₙ)ₙ₌₁^{N},i = 1,2,...,I}.

If more than one training sample is collected for a particular motion gesture, multiple templates may be created for the motion gesture. Even if each training sample is performed using different orientations, a consistent motion gesture template may be generated. The following example Add-Samples-Into-Template procedure may be used to combine the additional samples into the gesture template, without orientation dependency, where R is a new sample.

Add-Samples-Into-Template(R, {Tᵢ′(xₙ,yₙ)ₙ₌₁^{N}})

```
Resample R to length N;
Remove the gravity vector from R;
Scale R to the same level of magnitude as template;
Perform a PCA transformation on R;
Use the first and second strongest components of R;
Rescale these two components to the same level of magnitude;
Suppose the transformed data is R′(xₙ,yₙ)ₙ₌₁^{N};
  R′[1] = R′(xₙ,yₙ)ₙ₌₁^{N}; R′[2] = R′(−xₙ,yₙ)ₙ₌₁^{N};
  R′[3] = R′(xₙ,−yₙ)ₙ₌₁^{N}; R′[4] = R′(−xₙ,−yₙ)ₙ₌₁^{N};
For k=1,2,3,4
```

dist[k] = DTW(R′[k], Tᵢ′(xₙ,yₙ)ₙ₌₁^{N})

index = min⁻¹(dist[ ]);
Add R′[index] into {Tᵢ′(xₙ,yₙ)ₙ₌₁^{N}};

Having defined the motion gesture template, motion gesture test data can be captured and applied to determine whether a match can be found. In this regard, suppose the motion gesture test data is S(xₙ,yₙ,zₙ)ₙ₌₁^{M}, where M is the length of the test data sample.

It is noteworthy that, according to some example embodiments, the application of PCA causes the directional information of the acceleration values to be lost (in both the template data and the test data). As such, according to some example embodiments, a motion gesture that involves drawing a circle in clockwise direction may have equivalent PCA outputs as a motion gesture drawn in the anticlockwise direction. However, the significance of having gesture orientation independency far outweighs the value of afforded gesture directional information. Additionally, users may often be more interested in performing motion gestures of the same shape rather than performing motion gestures of the same shape, in the same direction.

Since the directional information in the motion gesture may be lost after PCA transformation, when DTW classifiers are used for gesture recognition, four variations of the transformed test data may need to be tested against the template data to determine if a gesture match is found. Accordingly, a modified DTW classifier may be generated in accordance with various example embodiments. The following example Modified-DTW-Classifier procedure provides one example for modifying the DTW classifier for orientation independent gesture recognition.

Modified-DTW-Classifier(S′,{Tᵢ′(xₙ,yₙ)ₙ₌₁^{N}}ᵢ₌₁^{I})

Resample S from length M to length N;
Remove the gravity vector from S;
Scale S to the same level of magnitude as template;
Perform a PCA transformation on S;
Use the first and second strongest components of S;
Rescale these two components to the same level of magnitude;
Suppose the transformed data is S′(xₙ,yₙ)ₙ₌₁^{N};
current_dist = infinity;
S′[1] = S′(xₙ,yₙ)ₙ₌₁^{N}; S′[2] = S′(−xₙ,yₙ)ₙ₌₁^{N};
S′[3] = S′(xₙ,−yₙ)ₙ₌₁^{N}; S′[4] = S′(−xₙ,−yₙ)ₙ₌₁^{N};
For each template set in {Tᵢ′(xₙ,yₙ)ₙ₌₁^{N}},i = 1,2,...,I,

For k=1,2,3,4

dist[k] = DTW(S′[k],avg {Tᵢ′(xₙ,yₙ)ₙ₌₁^{N}});

dist = min(dist[ ]);
if dist < current_dist

current_dist = dist;
index = i;

Return index;

For HMM classifiers, an individual HMM model may be learned or derived from each template set {T′ᵢ(xₙ,yₙ)ₙ₌₁^{N}}. A similar approach may then be applied to modify the HMM classifier for testing the four possibilities, however, with consideration of the maximum probability. The following example Modified-HMM-Classifier procedure provides one example for modifying the HMM classifier for orientation independent gesture recognition.

Modified-HMM-Classifier(S′,{Tᵢ′(xₙ,yₙ)ₙ₌₁^{N}}ᵢ₌₁^{I})

Resample S from length M to length N;
Remove the gravity vector from S;
Scale S to the same level of magnitude as template;
Perform a PCA transformation on S;
Use the first and second strongest components of S;
Rescale these two components to the same level of magnitude;
Suppose the transformed data is S′(xₙ,yₙ)ₙ₌₁^{N};
current_prob = 0;
S′[1] = S′(xₙ,yₙ)ₙ₌₁^{N}; S′[2] = S′(−xₙ,yₙ)ₙ₌₁^{N};
S′[3] = S′(xₙ,−yₙ)ₙ₌₁^{N}; S′[4] = S′(−xₙ,−yₙ)ₙ₌₁^{N};
For each template set in {Tᵢ′(xₙ,yₙ)ₙ₌₁^{N}},i = 1,2,...,I,

For k=1,2,3,4

prob[k] = HMM _Decode(S′(k),HMM _Model[i]);

prob = max(prob[ ]);
if prob > current_prob

current_prob = prob;
index = i;

Return index;

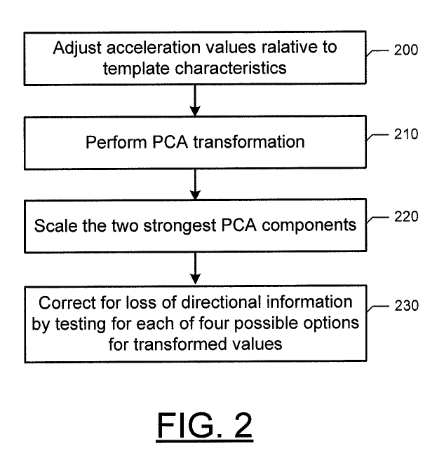

In view of the example embodiments provided above, FIG. 2 illustrates an example method for implementing a PCA-based solution. At 200, the example method includes adjusting the acceleration values relative to the template characteristics. In this regard, the adjustments may include resampling the data to achieve a common length with the template, removing the gravity vector from the data, scaling the data to achieve a common magnitude with the template, or the like. At 210, PCA transformation of the adjusted data may be performed. At 220, the first and second strongest PCA components may be commonly scaled. Finally, at 230, a correction for the loss of directional information may be performed by testing the result against the four possible quadrant options for the transformed values.

The example embodiments provided above utilize PCA as a mechanism for generating orientation independent acceleration values for use in motion gesture recognition. An alternative example technique, which may also be combined with the PCA techniques described above, may rely upon device orientation assumptions to determine rotational angles about each of the three dimensional axes to obtain orientation independent values.

In this regard, a heuristic technique may be employed to determine the third rotation angle under an assumption that a user often holds a device in a predictable relationship to a coordinate system defined with respect to the user's body. Accordingly, a full rotation matrix may be derived due to this assumption, which can be utilized to rotate motion gesture data onto a coordinate system that is based on the Earth and user's body.

According to various example embodiments, the third rotation angle may be determined by observing initial movement/acceleration values of the device, after the device has been rotated to a flat position parallel to Earth. Subsequently, the DTW or HMM classifiers may be applied on the rotated motion gesture test data for orientation independent gesture recognition.

As mentioned above, according to example embodiments of this alternative technique, some assumptions are considered. A first assumption may be that the device's top edge is furthest away from the user compared to the bottom edge. A second assumption may be that the initial orientation of the device is within +/−90 degrees of the z axis defined by the user's body (e.g., a device with a top edge pointing forward with respect to user's body is at 0 degrees relative to the z axis defined by the user's body). A third assumption may be that a two-dimensional vertical plane is used for motion gestures.

According to various example embodiments, the Earth may be used as a reference for motion gestures, and therefore the gravitational force or pull may be utilized as a basis for rotating the acceleration values. In this regard, the rotation may be performed such that the device may be considered to be in a flat position parallel to the Earth's ground and rotated such that the device is pointing to the North pole (azimuth plane) based on the Earth's magnetic field. By doing so, training template and test gesture data may be rotated to the Earth's frame thereby providing a common initial orientation of the device for all gestures.

The orientation information may be recorded just prior to the gesture and when the device is not moving. To be able to do this, the device may include an enabled accelerometer sensor to be able to monitor the gravitational force of the Earth and a magnetometer (or electronic compass) to be able to monitor magnetic/electric fields of the Earth for heading with in the azimuth plane. However, magnetometer interference and distortion of magnetic/electric fields can occur depending on the device's surroundings. If the device is located indoors, in a car, or surrounded by high rise buildings where metal structures exist, the magnetometer may be rendered inaccurate. Additionally, continuous calibration of the magnetometer may be required.

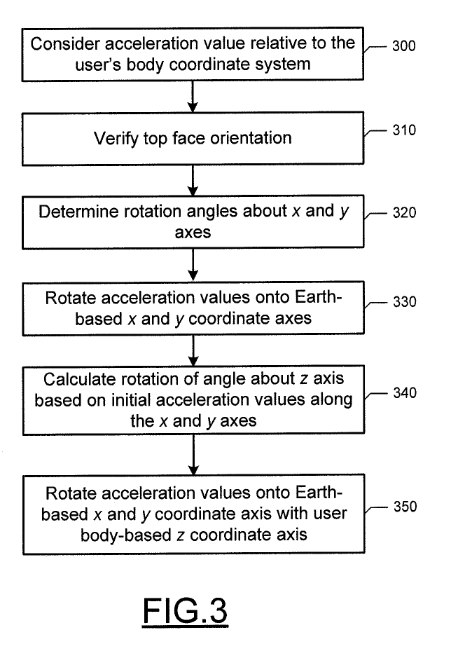

Therefore, rather than relying on the use of a magnetometer or similar hardware to rotate the device to a common reference point, example embodiments determine each of three dimensional angles of rotation to rotate the values provided by the accelerometer and determine a common initial orientation of the device. FIG. 3 provides an example method for rotating acceleration values into a predefined coordinate system to provide for orientation independent motion gesture recognition by determining the third angle rotated around the z-axis (ψ).

The example method begins at 300 where the acceleration values are considered relative to the user's body coordinate system. In this regard, the three dimensional accelerometer data x_{B}, y_{B}, z_{B} is considered in view of the assumptions described above, where B represents body frame of the user. At 310, the top face orientation of the device is verified. In this regard, a check may be performed to determine if the device's screen or top face is facing up towards the sky by monitoring the initial stationary orientation (just prior to gesture movement) of the device with the accelerometer z axis. If z axis acceleration is less than zero gravity, each y and z axis accelerometer data point may be multiplied by −1. By doing so, the device is forced to be oriented as if the top face (e.g., the side with the display screen) is facing towards the sky, and facilitates rotation calculations for this orientation.

At 320, the rotation angles about the x and y axes may be determined. One technique for determining the angles is to calculate Euler's angle for θ and φ (x and y axis) based on the initial orientation of the device using the gravitational force or pull. Refer again to FIG. 1 for axes assignments. Based on the direction of the gravitational force, which may be provided by an accelerometer, the rotated angle around x(θ) and y(φ) axis may be determined using Euler's method.

$$θ = arcsin ( \frac{{x}_{B}}{g} ) , ϕ = arctan ( \frac{{y}_{B}}{{z}_{B}} )$$

At 330, the acceleration values may be rotated onto Earth-based x and y coordinate axes. In this regard, each accelerometer data point x_{B}, y_{B}, z_{B} may be rotated to x_{E}, y_{E}, z_{E} causing a rotation from the user's body coordinate system to an Earth coordinate system for the x and y values. To calculate the rotations, the accelerometer values, in the form of a vector may be rotated using the rotation matrix R. As a result, the values have been modified as if the device had been rotated into a flat position, parallel to the Earth's ground. Rz(ψ) need not be included at this point, since no third angle rotation information exists.

a_{E}=[Rx(φ)Ry(θ)]⁻¹a_{B}

$$[ \begin{matrix}{x}_{E} \\ {y}_{E} \\ {z}_{E}\end{matrix} ] = [ \begin{matrix}cos θ & 0 & - sin θ \\ sin ϕsin θ & cos ϕ & sin ϕcos θ \\ cos ϕsin θ & - sin ϕ & cos ϕcos θ\end{matrix} ] [ \begin{matrix}{x}_{B} \\ {y}_{B} \\ {z}_{B}\end{matrix} ]$$

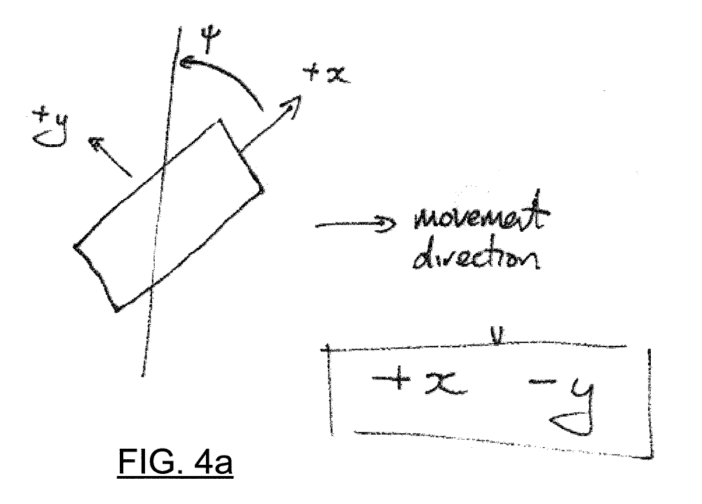

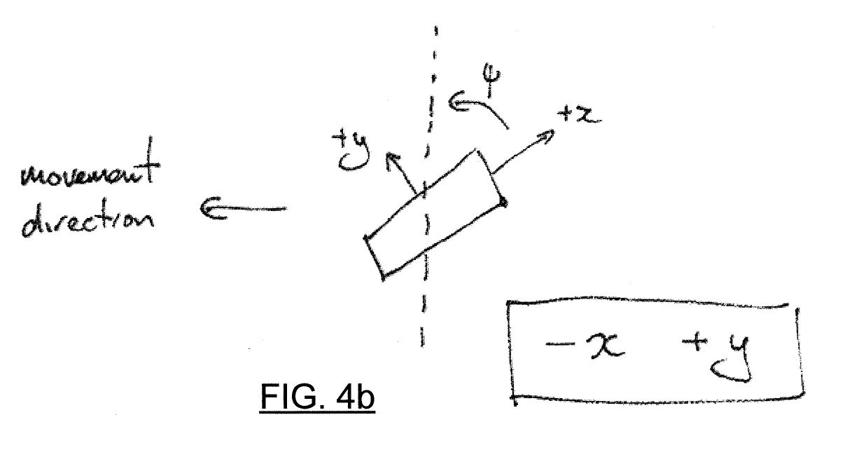

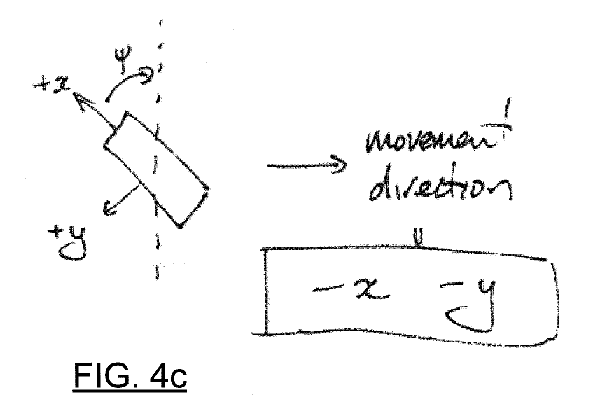

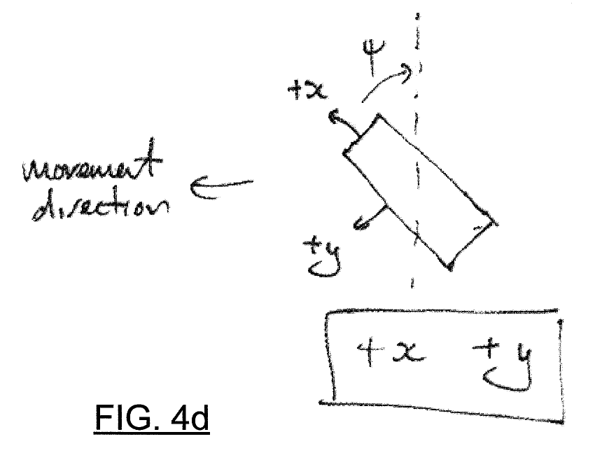

At 340, the rotation angle about the z axis may be calculated based on the rotated, initial acceleration values along the x and y axes. In this regard, at the initial point of the gesture movement, the initial values of x and y axis acceleration may be monitored. Using the table below, in association with the content FIGS. 4a-4c, the third rotation angle (azimuth plane (ψ)) may be calculated with respect the user's body. Based on the orientation of the x and y axes and the direction of movement, an angle rotation direction and the angle value may be determined. Accordingly, four possible relationships may be defined between the movement of the device, as depicted in FIGS. 4a-4d and the orientation of the x and y axes. Based on the appropriate relationship, a formula, as provided in Table 1 may be used to calculate the third rotational angle and direction. Within Table 1, −ve indicates a negative acceleration value and +ve indicates a positive acceleration value. Since the device is rotated in the flat position (parallel to Earth ground), the z axis may be excluded in the calculation for the third angle.

TABLE 1
Calculation for the third angle

| | x-axis | y-axis | Third Angle | Angle |
|---|---|---|---|---|
| Associated | Acceleration | Acceleration | Rotation | Calculation |
| FIG. | Initial Data | Initial Data | Direction | (ψ rad) |
| FIG. 4a | +ve | −ve | Anti-clockwise | atan2(y_{E}, x_{E}) + |
| | | | | pi/2 |
| FIG. 4b | −ve | +ve | Anti-clockwise | atan2(y_{E}, x_{E}) − |
| | | | | pi/2 |
| FIG. 4c | −ve | −ve | Clockwise | atan2(y_{E}, x_{E}) + |
| | | | | pi/2 |
| FIG. 4d | +ve | +ve | Clockwise | atan2(y_{E}, x_{E}) − |
| | | | | pi/2 |

At 350, the acceleration values may be rotated onto a coordinate system that is defined in the x and y axes relative to the Earth and in the z axis relative to the user's body. In this regard, each accelerometer data point calculated above may again be rotated from x_{E}, y_{E} to x_{E2}, y_{E2} and where z_{E2}=z_{E}. Accordingly, the values are now completely rotated relative to a common reference point. The x and y axes are rotated to Earth's frame with respect to the gravitational force of the Earth and z-axis is rotated with respect to the user's body, where the device is pointing forward.

a_{E2}=[Rz(ψ)]a_{E}

$$[ \begin{matrix}{x}_{E 2} \\ {y}_{E 2}\end{matrix} ] = [ \begin{matrix}cos ψ & - sin ψ \\ sin ψ & cos ψ\end{matrix} ] [ \begin{matrix}{x}_{E} \\ {y}_{E}\end{matrix} ]$$

The rotated values can then be applied to DTW or HMM classifiers to perform gesture recognition. The example methods of FIG. 3 have been described as being applied in a vertical plane. However, it is contemplated that other planes may be used by first finding the plane of the gesture being performed, for example, by using PCA (Principal Component Analysis), as described above, and then by applying the example methods described with respect to FIG. 3 to find the third rotation angle.

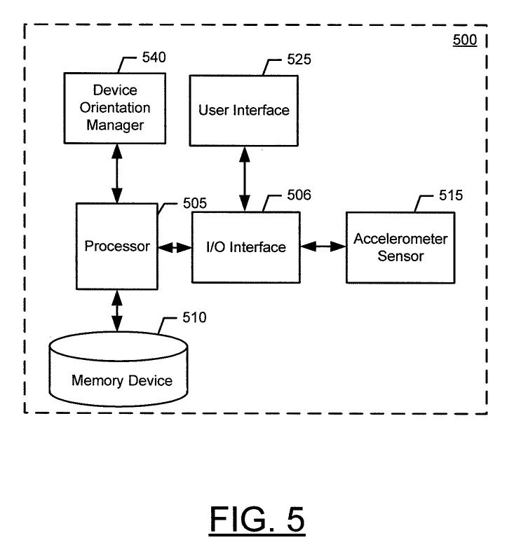

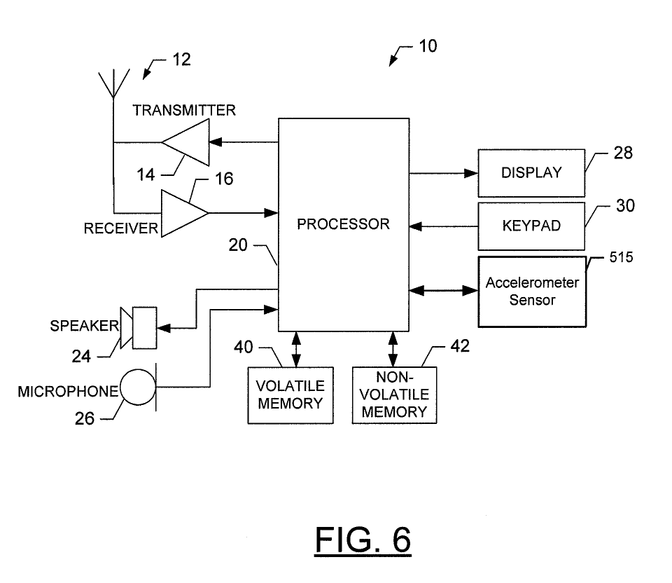

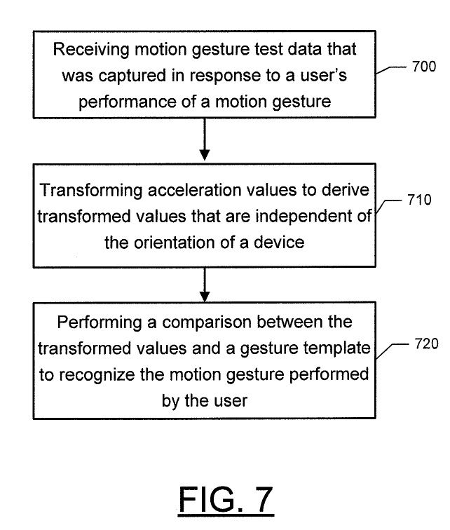

Having described some example embodiments above, FIGS. 5 and 6 depict example apparatuses that may be configured to perform various functionalities as described herein, including those described with respect to operations of FIGS. 2 and 3. Additionally, FIG. 7 illustrates an example method embodiment.

Referring now to FIG. 5, an example embodiment is depicted as apparatus 500, which may be embodied as an electronic device, such as a wireless communications device. In some example embodiments, the apparatus 500 may be part of a stationary or a mobile electronic device. As a mobile device, the apparatus 500 may be a mobile and/or wireless communications node such as, for example, a mobile and/or wireless server, computer, access point, handheld wireless device (e.g., telephone, tablet device, portable digital assistant (PDA), mobile television, gaming device, camera, video recorder, audio/video player, radio, digital book reader, and/or a global positioning system (GPS) device), any combination of the aforementioned, or the like. Regardless of the type of electronic device, apparatus 500 may also include computing capabilities.

FIG. 5 illustrates a block diagram of example components of the apparatus 500. The example apparatus 500 may comprise or be otherwise in communication with a processor 505, a memory device 510, an Input/Output (I/O) interface 506, a user interface 525, and a device orientation manager 540. The processor 505 may, according to some example embodiments, be embodied as various means for implementing the various functionalities of example embodiments including, for example, a microprocessor, a coprocessor, a controller, a special-purpose integrated circuit such as, for example, an ASIC (application specific integrated circuit), an FPGA (field programmable gate array), or a hardware accelerator, processing circuitry or the like. According to one example embodiment, processor 505 may be representative of a plurality of processors, or one or more multiple core processors, operating in concert. Further, the processor 505 may be comprised of a plurality of transistors, logic gates, a clock (e.g., oscillator), other circuitry, and the like to facilitate performance of the functionality described herein. The processor 505 may, but need not, include one or more accompanying digital signal processors. In some example embodiments, the processor 505 may be configured to execute instructions stored in the memory device 510 or instructions otherwise accessible to the processor 505. The processor 505 may be configured to operate such that the processor causes or directs the apparatus 500 to perform various functionalities described herein.

Whether configured as hardware or via instructions stored on a computer-readable storage medium, or by a combination thereof, the processor 505 may be an entity and means capable of performing operations according to example embodiments while configured accordingly. Thus, in example embodiments where the processor 505 is embodied as, or is part of, an ASIC, FPGA, or the like, the processor 505 may be specifically configured hardware for conducting the operations described herein. Alternatively, in example embodiments where the processor 505 is embodied as an executor of instructions stored on a computer-readable storage medium, the instructions may specifically configure the processor 505 to perform the algorithms and operations described herein. In some example embodiments, the processor 505 may be a processor of a specific device (e.g., mobile communications device) configured for employing example embodiments by further configuration of the processor 505 via executed instructions for performing the algorithms, methods, and operations described herein.

The memory device 510 may be one or more tangible and/or non-transitory computer-readable storage media that may include volatile and/or non-volatile memory. In some example embodiments, the memory device 510 comprises Random Access Memory (RAM) including dynamic and/or static RAM, on-chip or off-chip cache memory, and/or the like. Further, memory device 510 may include non-volatile memory, which may be embedded and/or removable, and may include, for example, read-only memory, flash memory, magnetic storage devices (e.g., hard disks, floppy disk drives, magnetic tape, etc.), optical disc drives and/or media, non-volatile random access memory (NVRAM), various type of solid-state storage (e.g., flash memory), and/or the like. Memory device 510 may include a cache area for temporary storage of data. In this regard, some or all of memory device 510 may be included within the processor 505. In some example embodiments, the memory device 510 may be in communication with the processor 505 and/or other components via a shared bus. In some example embodiments, the memory device 510 may be configured to provide secure storage of data, such as, for example, the characteristics of the reference marks, in trusted modules of the memory device 510.

Further, the memory device 510 may be configured to store information, data, applications, computer-readable program code instructions, and/or the like for enabling the processor 505 and the example apparatus 500 to carry out various functions in accordance with example embodiments described herein. For example, the memory device 510 may be configured to buffer input data for processing by the processor 505. Additionally, or alternatively, the memory device 510 may be configured to store instructions for execution by the processor 505.

The I/O interface 506 may be any device, circuitry, or means embodied in hardware or a combination of hardware and software that is configured to interface the processor 505 with other circuitry or devices, such as the user interface 525. In some example embodiments, the I/O interface may embody or be in communication with a bus that is shared by multiple components. In some example embodiments, the processor 505 may interface with the memory 510 via the I/O interface 506. The I/O interface 506 may be configured to convert signals and data into a form that may be interpreted by the processor 505. The I/O interface 506 may also perform buffering of inputs and outputs to support the operation of the processor 505. According to some example embodiments, the processor 505 and the I/O interface 506 may be combined onto a single chip or integrated circuit configured to perform, or cause the apparatus 500 to perform, various functionalities.

In some embodiments, the apparatus 500 or some of the components of apparatus 500 (e.g., the processor 505 and the memory device 510) may be embodied as a chip or chip set. In other words, the apparatus 500 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 500 may therefore, in some cases, be configured to implement embodiments on a single chip or as a single “system on a chip.” As such, in some cases, a chip or chipset may constitute means for performing the functionalities described herein and with respect to the processor 505.

The user interface 525 may be in communication with the processor 505 to receive user input via the user interface 525 and/or to present output to a user as, for example, audible, visual, mechanical, or other output indications. The user interface 525 may include, for example, a keyboard, a mouse, a joystick, a display (e.g., a touch screen display), a microphone, a speaker, camera, accelerometer, or other input/output mechanisms. Further, the processor 505 may comprise, or be in communication with, user interface circuitry configured to control at least some functions of one or more elements of the user interface. The processor 505 and/or user interface circuitry may be configured to control one or more functions of one or more elements of the user interface through computer program instructions (e.g., software and/or firmware) stored on a memory accessible to the processor 505 (e.g., volatile memory, non-volatile memory, and/or the like). The user interface 525 may also be configured to support the implementation of haptic feedback. In this regard, the user interface 525, as controlled by processor 505, may include a vibra, a piezo, and/or an audio device configured for haptic feedback as described herein. In some example embodiments, the user interface circuitry is configured to facilitate user control of at least some functions of the apparatus 500 through the use of a display and configured to respond to user inputs. The processor 505 may also comprise, or be in communication with, display circuitry configured to display at least a portion of a user interface, the display and the display circuitry configured to facilitate user control of at least some functions of the apparatus 500.

The accelerometer sensor 515 may be a hardware device that is configured to measures the direction and magnitude of the acceleration of the sensor and/or the apparatus 500. The accelerometer sensor 515 may be configured to provide acceleration directions and values to the processor 505, via the I/O 506, for analysis as described herein. The accelerometer may be a multi-axis accelerometer that provides the acceleration relative to a three-dimensional coordinate system that may be oriented in accordance with the particular orientation of the apparatus 500 at that time.

The device orientation manager 540 of example apparatus 500 may be any means or device embodied, partially or wholly, in hardware, a computer program product, or a combination of hardware and a computer program product, such as processor 505 implementing stored instructions to configure the example apparatus 500, memory device 510 storing executable program code instructions configured to carry out the functions described herein, or a hardware configured processor 505 that is configured to carry out the functions of the device orientation manager 540 as described herein. In an example embodiment, the processor 505 comprises, or controls, the device orientation manager 540. The device orientation manager 540 may be, partially or wholly, embodied as processors similar to, but separate from processor 505. In this regard, the device orientation manager 540 may be in communication with the processor 505. In various example embodiments, the device orientation manager 540 may, partially or wholly, reside on differing apparatuses such that some or all of the functionality of the device orientation manager 540 may be performed by a first apparatus, and the remainder of the functionality of the device orientation manager 540 may be performed by one or more other apparatuses.

Further, the apparatus 500 and the processor 505 may be configured to perform various functionalities via device orientation manager 540. In this regard, the device orientation manager 540 may be configured to implement the operations described herein. For example, the device orientation manager 540 may be configured to implement the functionality described above with respect to FIGS. 2 and 3, and otherwise described above. Further, according to some example embodiments, the In this regard, referring to FIGS. 5 and 7, the device orientation manager 540 may be configured to receive motion gesture test data that was captured in response to a user's performance of a motion gesture at 700. In this regard, the motion gesture test data may include acceleration values in each of three dimensions of space that have directional components that are defined relative to an orientation of a device. At 710, the device orientation manager 540 may be configured to transform the acceleration values to derive transformed values that are independent of the orientation of the device. Also, at 720, the device orientation manager 540 may be configured to perform a comparison between the transformed values and a gesture template to recognize the motion gesture performed by the user.

According to some example embodiments, the device orientation manager 540 may be further configured to perform a Principal Component Analysis (PCA) transformation on the acceleration values to derive two-dimensional transformed values. Additionally, or alternatively, the device orientation manager 540 may be configured to identify a highest valued component and a second highest valued component provided by the PCA transformation, and scale the highest valued component and the second highest valued component to a common magnitude level to generate the two-dimensional transformed values. Further, according to some example embodiments, performing the comparison between the transformed values and the gesture template may include applying Dynamic Time Warping (DTW) classifiers to the transformed values to perform gesture recognition or applying Hidden Markov Model (HMM) classifiers to the transformed values to perform gesture recognition.

Additionally, or alternatively, according to various example embodiments, the device orientation manager 540 may be configured to transform the acceleration values by determining a first rotation angle about a first axis and a second rotation angle about a second axis, rotating the acceleration values relative to an predefined frame to compute preliminary rotated acceleration values, and determining a third rotation angle about a third axis based on rotated acceleration values along the first axis and the second axis. Further, according to some example embodiments, transforming the acceleration values further comprises rotating the preliminary rotated acceleration value for the first axis based on the third rotation angle to derive a final rotated acceleration value for the first axis, and rotating the preliminary rotated acceleration value for the second axis based on the third rotation angle to derive a final rotated acceleration value for the second axis. Additionally, or alternately, according to some example embodiments, the device orientation manager 540 may be configured to determine a relationship between movement of the device and the orientation of the first axis and the second axis, and select a calculation for the third rotation angle based on the relationship.

Referring now to FIG. 6, a more specific example apparatus in accordance with various embodiments is provided. The example apparatus of FIG. 6 is a mobile device 10 configured to communicate within a wireless network, such as a cellular communications network. The mobile device 10 may be configured to perform the functionality of the device 100 or apparatus 500 as described herein. More specifically, the mobile device 10 may be caused to perform the functionality described with respect to FIGS. 2, 3, 7 and otherwise described above, via the processor 20. In this regard, according to some example embodiments, the processor 20 may be configured to perform the functionality described with respect to the device orientation manager 540. Processor 20 may be an integrated circuit or chip configured similar to the processor 505 together with, for example, the I/O interface 506. Further, volatile memory 40 and non-volatile memory 42 may be configured to support the operation of the processor 20 as computer readable storage media. Additionally, accelerometer sensor 515 may be configured to provide three-dimensional acceleration values for analysis as described herein.

The mobile device 10 may also include an antenna 12, a transmitter 14, and a receiver 16, which may be included as parts of a communications interface of the mobile device 10. The speaker 24, the microphone 26, display 28 (which may be a touch screen display), and the keypad 30 may be included as parts of a user interface.

FIGS. 2, 3, and 7 illustrate flowcharts of example systems, methods, and/or computer program products according to example embodiments. It will be understood that each operation of the flowcharts, and/or combinations of operations in the flowcharts, can be implemented by various means. Means for implementing the operations of the flowcharts, combinations of the operations in the flowchart, or other functionality of example embodiments described herein may include hardware, and/or a computer program product including a computer-readable storage medium (as opposed to a computer-readable transmission medium which describes a propagating signal) having one or more computer program code instructions, program instructions, or executable computer-readable program code instructions stored therein. In this regard, program code instructions for performing the operations and functions of FIGS. 2, 3, and 7 and otherwise described herein may be stored on a memory device, such as memory device 510, volatile memory 40, or volatile memory 42, of an example apparatus, such as example apparatus 500 or mobile device 10, and executed by a processor, such as the processor 505 or processor 20. As will be appreciated, any such program code instructions may be loaded onto a computer or other programmable apparatus (e.g., processor 505, memory device 510, or the like) from a computer-readable storage medium to produce a particular machine, such that the particular machine becomes a means for implementing the functions specified in the flowcharts' operations. These program code instructions may also be stored in a computer-readable storage medium that can direct a computer, a processor, or other programmable apparatus to function in a particular manner to thereby generate a particular machine or particular article of manufacture. The instructions stored in the computer-readable storage medium may produce an article of manufacture, where the article of manufacture becomes a means for implementing the functions specified in the flowcharts' operations. The program code instructions may be retrieved from a computer-readable storage medium and loaded into a computer, processor, or other programmable apparatus to configure the computer, processor, or other programmable apparatus to execute operations to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provide operations for implementing the functions specified in the flowcharts' operations.

Accordingly, execution of instructions associated with the operations of the flowchart by a processor, or storage of instructions associated with the blocks or operations of the flowcharts in a computer-readable storage medium, support combinations of operations for performing the specified functions. It will also be understood that one or more operations of the flowcharts, and combinations of blocks or operations in the flowcharts, may be implemented by special purpose hardware-based computer systems and/or processors which perform the specified functions, or combinations of special purpose hardware and program code instructions.

Many modifications and other embodiments set forth herein will come to mind to one skilled in the art to which these embodiments pertain having the benefit of the teachings presented in the foregoing descriptions and the associated drawings. Therefore, it is to be understood that the embodiments are not to be limited to the specific ones disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

What is claimed is:

1. A method comprising:
receiving motion gesture test data that was captured in response to a user's performance of a motion gesture, the motion gesture test data including acceleration values in each of three dimensions of space that have directional components that are defined relative to an orientation of a device;
transforming, via a processor, the acceleration values to derive transformed values that are independent of the orientation of the device; and
performing a comparison between the transformed values and a gesture template to recognize the motion gesture performed by the user.

2. The method of claim 1, wherein transforming the acceleration values includes performing a Principal Component Analysis (PCA) transformation on the acceleration values to derive two-dimensional transformed values.

3. The method of claim 2, wherein deriving the two-dimensional transformed values includes:
identifying a highest valued component and a second highest valued component provided by the PCA transformation; and
scaling the highest valued component and the second highest valued component to a common magnitude level to generate the two-dimensional transformed values.

4. The method of claim 2, wherein performing the comparison between the transformed values and the gesture template includes applying Dynamic Time Warping (DTW) classifiers to the transformed values to perform gesture recognition or applying Hidden Markov Model (HMM) classifiers to the transformed values to perform gesture recognition.

5. The method of claim 1, wherein transforming the acceleration values includes:
determining a first rotation angle about a first axis and a second rotation angle about a second axis;
rotating the acceleration values relative to an predefined frame to compute preliminary rotated acceleration values; and
determining a third rotation angle about a third axis based on rotated acceleration values along the first axis and the second axis.

6. The method of claim 5, wherein transforming the acceleration values further comprises:
rotating the preliminary rotated acceleration value for the first axis based on the third rotation angle to derive a final rotated acceleration value for the first axis; and
rotating the preliminary rotated acceleration value for the second axis based on the third rotation angle to derive a final rotated acceleration value for the second axis.

7. The method of claim 5, wherein determining the third rotation angle includes determining a relationship between movement of the device and the orientation of the first axis and the second axis; and selecting a calculation for the third rotation angle based on the relationship.

8. An apparatus comprising:
at least one processor; and
at least one memory comprising computer program code, the at least one memory and the computer program code configured to, with the at least one processor, cause the apparatus at least to:
receive motion gesture test data that was captured in response to a user's performance of a motion gesture, the motion gesture test data including acceleration values in each of three dimensions of space that have directional components that are defined relative to an orientation of a device;
transform the acceleration values to derive transformed values that are independent of the orientation of the device; and
perform a comparison between the transformed values and a gesture template to recognize the motion gesture performed by the user.

9. The apparatus of claim 8, wherein the apparatus caused to transform the acceleration values includes being caused to perform a Principal Component Analysis (PCA) transformation on the acceleration values to derive two-dimensional transformed values.

10. The apparatus of claim 9, wherein the apparatus caused to derive the two-dimensional transformed values includes being caused to:
identify a highest valued component and a second highest valued component provided by the PCA transformation; and
scale the highest valued component and the second highest valued component to a common magnitude level to generate the two-dimensional transformed values.

11. The apparatus of claim 9, wherein the apparatus caused to perform the comparison between the transformed values and the gesture template includes being caused to apply Dynamic Time Warping (DTW) classifiers to the transformed values to perform gesture recognition or apply Hidden Markov Model (HMM) classifiers to the transformed values to perform gesture recognition.

12. The apparatus of claim 8, wherein the apparatus caused to transform the acceleration values includes being caused to:
determine a first rotation angle about a first axis and a second rotation angle about a second axis;
rotate the acceleration values relative to an predefined frame to compute preliminary rotated acceleration values; and
determine a third rotation angle about a third axis based on rotated acceleration values along the first axis and the second axis.

13. The apparatus of claim 12, wherein the apparatus caused to transform the acceleration values includes being caused to:
rotate the preliminary rotated acceleration value for the first axis based on the third rotation angle to derive a final rotated acceleration value for the first axis; and
rotate the preliminary rotated acceleration value for the second axis based on the third rotation angle to derive a final rotated acceleration value for the second axis.

14. The apparatus of claim 12, wherein the apparatus caused to determine the third rotation angle includes being caused to determine a relationship between movement of the device and the orientation of the first axis and the second axis; and select a calculation for the third rotation angle based on the relationship.

15. The apparatus of claim 8, wherein the apparatus comprises a mobile device.

16. The apparatus of claim 15, wherein the apparatus further comprises an accelerometer configured to capture the motion gesture test data.

17. A computer program product comprising at least one non-transitory computer readable medium having program code stored thereon, wherein the program code, when executed by an apparatus, causes the apparatus at least to:
receive motion gesture test data that was captured in response to a user's performance of a motion gesture, the motion gesture test data including acceleration values in each of three dimensions of space that have directional components that are defined relative to an orientation of a device;
transform the acceleration values to derive transformed values that are independent of the orientation of the device; and
perform a comparison between the transformed values and a gesture template to recognize the motion gesture performed by the user.

18. The computer program product of claim 17, wherein the program code that causes the apparatus to transform the acceleration values also causes the apparatus to perform a Principal Component Analysis (PCA) transformation on the acceleration values to derive two-dimensional transformed values.

19. The computer program product of claim 17, wherein the program code that causes the apparatus to transform the acceleration values also causes the apparatus to:
determine a first rotation angle about a first axis and a second rotation angle about a second axis;
rotate the acceleration values relative to an predefined frame to compute preliminary rotated acceleration values; and
determine a third rotation angle about a third axis based on rotated acceleration values along the first axis and the second axis.

20. The computer program product of claim 19, wherein the program code that causes the apparatus to transform the acceleration values also causes the apparatus to:
rotate the preliminary rotated acceleration value for the first axis based on the third rotation angle to derive a final rotated acceleration value for the first axis; and
rotate the preliminary rotated acceleration value for the second axis based on the third rotation angle to derive a final rotated acceleration value for the second axis.
